(19) United States
(12) Patent Application Publication
(10) Pub. No.: US 2008/0146764 A1
(43) Pub. Date: Jun. 19, 2008

(54) Solutions of blocked polyimides or polyamideimides

(76) Inventors: Rolf Gertzmann, Leverkusen (DE); Beate Baumbach, Burscheid (DE); Reinhard Halpaap, Odenthal (DE); Wolfram Kuettner, Bergisch Gladbach (DE)

Correspondence Address: BAYER MATERIAL SCIENCE LLC, 100 BAYER ROAD, PITTSBURGH, PA, 15205, US

(21) Appl. No.: 11/978,917

(22) Filed: Oct. 30, 2007

(30) Foreign Application Priority Data
Nov. 3, 2006 (DE) 102006052240.0

(51) Int. Cl. C08G 18/81

(52) U.S. Cl. 528/45

(57) ABSTRACT

The present invention provides a process for preparing aqueous solutions of NCO group blocked resins having polyimide structures and optionally, polyamide structures. The process comprises the steps of preparing a polymer from at least one polyisocyanate, at least one tricarboxylic monoanhydride and/or at least one tetracarboxylic anhydride, and optionally, tricarboxylic acids, tetracarboxylic acids and/or dicarboxylic acids, at least one NH-functional lactam and/or 3,5-dimethylpyrazole and/or butanone oxime. The reaction mixture is subsequently reacted with a base, and the resulting resin is dissolved in water. The resins provide high-grade, highly flexible coatings having the excellent properties and chemical resistance typical of polyamideimides.

### CROSS-REFERENCE TO RELATED APPLICATION

This application claims priority under 35 U.S.C. §119(a-d) to German application DE 10 2006 052240.0, filed Nov. 3, 2006.

### FIELD OF THE INVENTION

The present invention relates to aqueous solutions of resins containing polyimide structure and also, where appropriate, polyamide structure and having blocked isocyanate groups (also referred to below as “polyimides or polyamideimides” or “polyimide or polyamideimide resins”), said resins being readily processable to give high-grade, highly flexible coatings having the excellent properties and chemical resistance typical of polylamideimides, to a process for preparing them and to their use.

### BACKGROUND OF THE INVENTION

JP 2005 120134 describes water-soluble polyamideimides which are obtained by reacting aromatic polyisocyanates and tribasic acid anhydrides. In order to attain good coating properties for the aqueous products, high molecular weight polymers with number-average molecular weights of between 5000 and 50 000 g/mol are brought into the aqueous phase. The high molecular weight is brought about by deliberate selection of the ratio of equivalents of isocyanate groups to acid groups and anhydride groups. It is noted that, although molecular weights below 5000 g/mol simplify the handling and hence the dispersing of the resin, the properties of the products are nevertheless reduced. The desire is for resins and their solutions which have good processing properties but at the same time lead to coatings having a high level of properties. U.S. Pat. No. 4,259,221 describes likewise water-soluble polyamideimides whose solutions have possible uses which include their use as coating compositions. According to that document polyamideimides can be obtained, for example, from the reaction of polyamines with carboxylic anydrides in a slight excess.

It is possible optionally to react the resultant polyamideimides with blocked or non-blocked polyisocyanates as well. The examples do not detail any such reactions, either with non-blocked isocyanates or with blocked isocyanates. No statement can be inferred relating to the processing properties of the polyamideimides or of their solutions from the US specification.

U.S. Pat. No. 4,429,073 describes water-soluble polyetherimides which are obtainable, for example, from the reaction of bis(ether anhydrides) with polyamines. Following the cleavage of the imide with water in the presence of an amine, it is possible, through addition of a trifunctional isocyanate component, for crosslinking to take place, this crosslinking being promoted by blocking on the isocyanate. The examples use an alcohol, or phenol, as blocking agent. The crosslinked coatings obtained do not have sufficient flexibility and adhesion for all requirements.

In the non-aqueous sector as well, polyamideimides and polyimides are well know. For instance, in DE 1770202 A1 and DE 3332033 A1, high molecular weight polyamideimides are synthesized from polycarboxylic anhydrides, lactams and polyisocyanates, these components being subjected to addition reaction with one another, with ring-opening of the lactam. The resulting polymers feature a particularly good temperature stability (DE 1770202), but are of high viscosity and must therefore be processed at high temperatures. The specification does not allow any statement concerning other qualities of these films. Further reaction of the polymers with selected lactams leads, as described in DE 3332033, to thermoplastics having good mechanical properties.

DE 19524437 concerns itself with low molecular mass blocked polyisocyanates, containing amide/imide groups, in a non-aqueous system, which are obtained by reacting, in any order, polyisocyanates with blocking agents for isocyanate groups, compounds containing at least two carboxyl and/or carboxylic anhydride groups, and, where appropriate, polyhydroxy compounds. These paint isocyanates serve for crosslinking with OH-functional binders in a system composed of two different components.

The two Japanese specifications JP 58-002097 and JP59-137454 report on lactam and blocked polyamideimide resins from the reaction of aromatic diisocyanates with tricarboxylic anhydrides and the blocking agent in the presence of basic solvents. Optionally the lactam-blocked polyamideimide resins can also be reacted with bases, further blocked isocyanates, and polyester resins, for the purpose of more rapid curing of the films obtained from them, and an improvement in the flexibility and heat shock of the coatings obtained.

### SUMMARY OF THE INVENTION

Surprisingly it has now been found that aqueous solutions of polyamideimides or polyimides are easy to process and, after baking, produce coatings having high resistance and high flexibility when, specifically, the NCO groups of the polymer chains are partly blocked at the preparation stage.

The invention provides a process for preparing aqueous solutions of NCO group blocked resins having number-average molecular weights (Mₙ) of 1000 to 7000 g/mol which contain polyimide structures and optionally polyamide structures as well, characterized in that

first, a polymer is prepared from
a) at least one polyisocyanate
b) at least one tricarboxylic monoanhydride and/or at least one tetracarboxylic anhydride and also
   b1) optionally, tricarboxylic acids and/or tetracarboxylic acids and
   b2) optionally, dicarboxylic acids,
c) at least one NH-functional lactam and/or 3,5-dimethylpyrazole and/or butanone oxime,

to which, optionally, further amounts of the following are added:
d) at least one tricarboxylic monoanhydride and/or at least one tetracarboxylic anhydride and also
   d1) optionally, tricarboxylic acids and/or tetracarboxylic acids and
   d2) optionally, dicarboxylic acids,

the amount of isocyanate groups of component a) to the sum total of the amounts of the isocyanate-reactive groups of components b), b1), b2), d), d1) and d2) being used in a molar ratio of 0.90:1 to 1.3:1, and the amount of isocyanate groups of component a) to the amount of isocyanate-reactive groups of component c) being used in a molar ratio of 1:0.05 to 1:0.35,

the reaction mixture is subsequently reacted with
e) a base,

the amount of acid and/or anhydride groups of components b), b1), b2), d), d1) and d2) to the amount of basic groups of component e) being used in a molar ratio of 1:0.5 to 1:4,

and the resulting resin, lastly, is dissolved in water;

it being possible to add the water to the resin, or else the resin is added to the water.

Furthermore, the aqueous solutions obtainable by this process are also provided by the invention.

### DETAILED DESCRIPTION OF THE INVENTION

As used herein in the specification and claims, including as used in the examples and unless otherwise expressly specified, all numbers may be read as if prefaced by the word “about”, even if the term does not expressly appear. Also, any numerical range recited herein is intended to include all sub-ranges subsumed therein.

For the purposes of this invention a solution means a homogeneous solution or a colloidal solution through to a finely divided dispersion. In this text the term “water-soluble” also means “water-dispersible”.

The water-soluble NCO group blocked resins containing polyimide structure and, where appropriate, polyamide structure, preferably have number-average molecular weights (Mₙ) of 1000 to 6000 and more preferably of 1200 to 5000 g/mol.

The amount of isocyanate groups of component a) to the sum total of the amounts of isocyanate-reactive groups of components b), b1), b2), d), d1) and d2) is used preferably in a molar ratio of 0.95:1 to 1.15:1, the amount of isocyanate groups of component a) to the amount of isocyanate-reactive groups of component c) is used preferably in a molar ratio of 1:0.05 to 1:0.35, and the amount of basic groups of component e) to the amount of acid and/or anhydride groups of components b), b1), b2), d), d1) and d2) is used preferably in a molar ratio of 1:1 to 2:1.

Polyisoycanates a) suitable for preparing the resins that are present in the solutions according to the invention are aromatic polyisocyanates, aliphatic or cycloaliphatic polyisocyanates. Preferred polyisocyanates are those having a unitary or mean average molecular weight of 140 to 500 g/mol, with a statistical mean average NCO functionality of not more than 2.6.

Polyisocyanates of this kind are, for example, 1,4-phenylene diisocyanate, 2,4- and 2,6-diisocyanatotoluene (TDI) and any desired mixtures of these isomers, 4,4′-, 2,4′- and 2,2′-diisocyanatodiphenylmethane (MDI) or any desired mixtures of these isomers, or mixtures of these isomers with their higher homologues, of the kind obtained in conventional manner by phosgenation of aniline/formaldehyde condensates, 1,5-naphthylene diisocyanate 1,4-butane diisocyanate, 2-methylpentane 1,5-diisocyanate, 1,5-hexane diisocyanate, 1,6-hexane diisocyanate (HDI), 1,3- and 1,4-cyclohexane diisocyanate and any desired mixtures of these isomers, 2,4- and 2,6-diisocyanato-1-methylcylohexane and any desired mixtures of these isomers, 3,5,5-trimethyl-3-isocyanato-methylcylohexane isocyanate and dicyclohexylmethane 2,4′- and 4,4′-diisocyanate, and any desired mixtures of these diisocyanates.

Preferred polyisocyanates a) used are those having isocyanate groups attached to aromatic fragments, with a statistical mean average NCO functionality of 2 to 2.2 and an optionally statistical mean average molecular weight of 174 to 300 g/mol.

Diisocyanates whose use is especially preferred are 4,4′-, 2,4′- and 2,2′-diisocyanatodiphenylmethane or any desired mixtures of these isomers.

Suitability as component b) is possessed by cyclic tricarboxylic monoanhydrides such as trimellitic anhydride, hemimellitic anhydride and benzophenone-3,4,3′-tricarboxylic anhydride, and tetracarboxylic dianhydrides such as pyromellitic anhydride and benzophenone-3,3′,4,4′-tetracarboxylic dianhydride, or mixtures of these compounds. Preference is given to tricarboxylic monoanhydrides such as trimellitic anhydride, hemimellitic anhydride and benzophenone-3,4,3′-tricarboxylic anhydride. A particularly preferred component b) is trimellitic anhydride.

Optionally it is also possible to use, at least proportionally, the tricarboxylic and/or tetracarboxylic acids b1) formed from the components b) by hydrolysis.

Optionally it is possible, proportionally, to use aliphatic, alicyclic or aromatic dicarboxylic acids and/or their anhydrides b2) as well in order to modify the properties of the coatings to meet the requirements. In this way, for example, the coating may be elastified. Suitable components b2) include succinic, glutaric, adipic, pimelic suberic, azelaic, sebacic, nonanedicarboxylic, decanedicarboxylic, terephthalic, isophthalic, o-phthalic, tetrahydrophthalic and hexahydrophthalic acid and also acid anhydrides, such as o-phthalic anhydride or succinic anhydride.

Suitable blocking agents c) for the NCO groups of component a) include 3,5-dimethylpyrazole, butanone oxime and lactams with secondary amide nitrogen atoms, such as ε-caprolactam, δ-valerolactam and butyrolactam, for example. Preferred components c) are 3,5-dimethylpyrazole and ε-caprolactam. A particularly preferred component c) is ε-caprolactam. Likewise suitable as blocking agents c) are mixtures of the said blocking agents c). Particular suitability is possessed by mixtures of 3,5-dimethylpyrazole and ε-caprolactam in a molar ratio of 0.1:0.9 to 0.9:0.1.

Independently of one another the compounds that are suitable as components d), d1) and d2) are the same compounds already listed as component b), b1) and b2).

Suitability as component e) is possessed for example by alkyl group substituted amines which carry no further functional groups. These include propylamine, butylamine, dibutylamine, trimethylamine, triethylamine, tributylamine, dimethylisopropylamine, ethyldiisopropylamine, dimethylcyclohexylamine, N-methylmorpholine and N-ethylmorpholine. Also suitable, moreover, are further organic amines e) which contain further reactive groups, such as ethanolamine, diethanolamine, N,N-dimethylethanolamine, N-methyldiethanolamine and triethanolamine, for example. Preference is given to those amines which are trialkyl-substituted, such as trimethylamine, triethylamine, tributylamine, dimethylisopropylamine, ethyldiisopropylamine, dimethylcyclohexylamine, N-methylmorpholine, N-ethylmorpholine, N,N-dimethylethanolamine, N-methyldiethanolamine and triethanolamine. Of particularly preferred suitability as component e) are compounds which carry tertiary amine and OH groups, such as N,N-dimethylethanolamine, N-methyldiethanolamine and triethanolamine.

To reduce the viscosity of the resins it is preferred to use solvents which allow the resin to be soluble or dispersible. Suitable solvents are those which do not have isocyanate-reactive groups and which are capable of dissolving the resins at temperatures below 150° C. This group of solvents includes dimethyl sulphoxide, dimethylacetamide, dipropylene glycol dimethyl ether, N-methylpyrrolidone, N-ethylpyrrolidone, N-cyclohexylpyrrolidone, N-octylpyrrolidone, N-methylbutyrolactam, N-methylvalerolactam and N-methylcaprolactam. Preferred solvents are N-methylpyrrolidone, N-ethylpyrrolidone, N-methylbutyrolactam, N-methylvalerolactam and N-methylcaprolactam. Particularly preferred solvents are N-methylpyrrolidone and N-ethylpyrrolidone. Mixtures of the stated solvents are likewise suitable, more particularly those mixtures of N-ethylpyrrolidone with N-methylpyrrolidone, dimethyl sulphoxide, dimethylacetamide or dipropylene glycol dimethyl ether.

The amount of the solvent is calculated such that it is possible for the carbon dioxide produced by the reaction of isocyanate groups with carboxylic acid groups to escape rapidly. In this way, foaming of the mixture in the reaction vessel is prevented. Moreover, the amount of solvent ought to be selected so that the viscosity of the resins is sufficiently low that they can subsequently be dispersed or dissolved in water. The viscosity that is necessary for successful dispersing is hence also dependent on factors which include the effectiveness of the dispersing apparatus.

The amount of solvent, based on the sum of the raw materials a), b), b1), b2), d), d1), d2) and c) employed, is preferably 20 to 100% by weight, more preferably 30% to 90% by weight and with particular preference 40% to 80% by weight.

The solutions of the invention are prepared in two or more steps. First of all, components a) to c) are reacted with one another in any order at temperatures of 20 to 80° C., with the proviso that when component c) is added it is opposed by at least the equimolar amount of NCO groups, so that the complete incorporation of the component is ensured. The temperature regime or else the rate at which the components are added is selected such that the evolution of CO₂ is controlled and the emergence of the reaction mixture from the reaction vessel is prevented. Moreover, any amount of foam that is formed must only be such that sufficient comixing is ensured. In the further course of the reaction, the reaction temperature is raised to about 110° C. to 150° C., so that, over the time, the course of the reaction is extremely uniform. The reaction mixture is held at the final temperature until the amount of CO₂ deposited is 90% to 120%, preferably from 95% to 110% and very preferably 98% to 110% of theory.

In one preferred embodiment the blocking agent c) and also components b), b1) and b2) are introduced, completely or else only in part, and are diluted with a portion or else with the total amount of solvent. The components can be mixed in temperatures of 10° C. to 150° C., although mixing takes place preferably at 20 to 80° C. When the raw materials are completely dissolved, component a) and any retained amounts of b), b1), b2) and/or c) are added, completely or in stages, at temperatures of 20° C. to 80° C. Any retained amounts of solvent can be metered in at any desired point. Additionally, the procedure described above is followed.

It is likewise preferred to introduce component a) initially and to meter in components b), b1), b2) and c) individually or in a mixture, preferably in a mixture, at the temperatures already recited above, completely or in stages.

It is also possible first to proceed in accordance with one of the above embodiments and then to add components d), d1) and/or d2) to the solution of the resulting polymer, so that the amount of isocyanate groups of component a) to the sum total of the amounts of the isocyanate-reactive groups of components b), b1), b2), d), d1) and d2) is in a molar ratio of 0.90:1 to 1.3:1, preferably 0.95:1 to 1.15:1.

When the target amount of CO₂ has been eliminated in one of the selected embodiments, and, where appropriate, component d), d1) and/or d2) has been added to the polymer solution, component e) is added at temperatures of 10 to 100° C., preferably 30 to 80° C., more preferably 40 to 80° C., and the components are stirred for 0.5 up to a maximum of 20 h.

Subsequently water is added to the resin solution with shearing. The amount of water is calculated such that the solids content of the aqueous resins is 10% to 40% by weight, preferably 15% to 35% by weight and more preferably 20% to 30% by weight.

The temperature of the water is 20 to 100° C., preferably 40 to 80° C. and more preferably 50 to 80° C. The mixture is stirred with sufficient energy input until a homogeneous solution or finely divided dispersion is obtained. After that the aqueous supply form of the resin is cooled.

In another embodiment the resin is supplied to the water rather than the water to the resin—under otherwise unchanged conditions as compared with the first embodiment.

The resulting aqueous solutions of NCO group blocked polyamideimide or polyimide resins according to the invention can be used as coating compositions or for producing coating compositions. Preferably they are applied alone as a thermally curable 1-component baking system. Alternatively they can be blended in a blend with preferaby OH-functional, but also with OH-free, aqueous binders and processed as a 1-component baking system. Suitable aqueous binders include the OH-containing or OH-free primary or secondary polyacrylate dispersions, secondary polyester-polyacrylate dispersions, and polyurethane dispersions that are typical in paint chemistry.

Further provided by the present invention are coating compositions obtainable using the aqueous solutions of NCO group blocked resins containing polyimide structure and also, where appropriate, polyamide structure, according to the invention, and also the coatings and coated substrates obtainable from them.

The coating compositions of the invention can be applied to substrates such as metal, plastic, glass or mineral substrates, for example, and also to substrates that have already been coated. One preferred application is the use of the coating compositions of the invention to produce coatings on metal. One particularly preferred application is the use of the coating compositions of the invention to coat metal packaging forms, particularly in the can coating segment.

The coating compositions of the invention may where appropriate also comprise the auxiliaries and additives that are known per se from paint technology, such as fillers and pigments, for example.

The coating compositions can be applied in known ways, such as by spreading, pouring, knife coating, injecting, spraying, spin coating, rolling or dipping, for example.

The baking of the coatings takes place after prior drying—flashing off—of the coating at room temperature in a single-stage or multi-stage process. Baking preferably takes place in a two-stage operation, in which drying is carried out first for 1 to 20 minutes, preferably 2 to 10 minutes, at 50 to 130° C., preferably at 70 to 100° C., and then, in the second step, for 1 to 10 minutes, preferably 2-7 minutes, at temperatures between 180 and 300° C., preferably 200-280° C. The increase in temperature may also be continuous, in appropriate ovens, in order to ensure optimum baking.

### EXAMPLES

The viscosity was measured using a Physika MC 51 cone/plate viscometer from Anton Paar.

IR spectroscopy was carried out on an MB series FTIR spectroscope from Bomem.

Determination method for solids content: drying of the aqueous solution in a forced-air oven at 200° C. for 3 h.

GPC: The eluent used was N,N-dimethylacetatamide with a flow rate of 0.6 ml/min. The stationary phase used comprised four columns, HEMA 3000, HEMA 300, HEMA 40, HEMA 40, from Polymer Standards Service, Mainz, Germany. Each column has a length of 300 mm and a diameter of 8 mm. The particle size of the packing materials is 10 μm.

### Example 1

a) Preparation of a Polyamideimide Resin 1

282.5 g of ε-caprolactam and 1920 g of trimellitic acid anhydride were weighed out into a three-necked flask equipped with KPG stirrer. Via a gas take-off tube, the flask was connected to a gas meter, in order to determine the amount of CO₂ formed during the reaction. 3932.5 g of N-ethylpyrrolidone were added to the raw materials mixture. Over the course of 5 minutes 2500 g of 4,4′-diisocyanatodiphenylmethane were added at room temperature to the homogeneous mixture, before the temperature was raised to 80° C. over the course of 30 minutes. From about 65° C., an exothermic reaction and evolution of gas were observed. When the temperature reached 83° C. it was raised at half-hour intervals by 10° C. up to a final temperature of 133° C. The reaction mixture was held at that temperature until 100% (17.5 mol) of the amount of CO₂ indicated theoretically was detected at the gas meter. At the end of the reaction, no significant amounts of NCO groups in the typical cumulene region at approximately 2100 cm⁻¹ were detectable any more by IR spectroscopy.

Viscosity (mixture of 1 part by weight of resin with 3 parts by weight of N-ethylpyrrolidone): 1000 mPa s at 23° C. (D=100 s⁻¹)

Mₙ=3900 g/mol; M_{w}=9112 g/mol

b) Preparation of the Aqueous Solution 1

850.4 g of the resin solution, heated at 80° C., were admixed with 254.5 g of dimethylethanolamine with stirring. Following full homogenization of the mixture, the neutralized resin was admixed at 80° C. with 1000 g of water, which had been heated at 70° C., over the course of 10 minutes. This was followed by stirring at 90° C. for 2 h. A transparent solution reddish brown in colour was obtained.

Solids content: 21%

Viscosity: 1900 m Pa s at 23° C. (D=1000 s⁻¹)

Mₙ=3770 g/mol; M_{w}=8098 g/mol

### Example 2

a) Preparation of a Polyamideimide Resin 2

240 g of 3,5-dimethylpyrazole and 1920 g of trimellitic acid anhydride were weighed out into a three-necked flask equipped with KPG stirrer. Via a gas take-off tube, the flask was connected to a gas meter, in order to determine the amount of CO₂ formed during the reaction. 3800 g of N-ethylpyrrolidone were added to the raw materials mixture. Over the course of 5 minutes 2500 g of 4,4′-diisocyanatodiphenylmethane were added at room temperature to the homogeneous mixture, before the temperature was raised to 80° C. over the course of 30 minutes. From about 65° C., an exothermic reaction and evolution of gas were observed. When the temperature reached 83° C. it was raised at half-hour intervals by 10° C. up to a final temperature of 133° C. The reaction mixture was held at that temperature until 104% of the amount of CO₂ indicated theoretically was detected at the gas meter. At the end of the reaction, no significant amounts of NCO groups were detectable any more by IR spectroscopy.

Viscosity (mixture of 1 part by weight of resin with 3 parts by weight of N-ethylpyrrolidone): 4380 mPa s at 23° C. (D=100 s⁻¹)

Mₙ=4980 g/mol; M_{w}=16 740 g/mol

b) Preparation of the Aqueous Solution 2

850.4 g of the resin solution, heated at 80° C., were admixed with 254.5 g of dimethylethanolamine with stirring. Following full homogenization of the mixture, the neutralized resin was admixed at 80° C. with 1000 g of water, which had been heated at 70° C., over the course of 10 minutes. This was followed by stirring at 90° C. for 2 h. A transparent solution reddish brown in colour was obtained.

Solids content: 22%

Viscosity: 2510 mPa s at 23° C. (D=1000 s⁻¹)

Mₙ=4490 g/mol; M_{w}=12 990 g/mol

### Comparative Example 3 (in Analogy to Ex. 1 JP 2005 120134)

a) Preparation of a Blocking Agent-Free Polyamideimide Resin 3

1920 g of trimellitic acid anhydride were weighed out into a three-necked flask equipped with KPG stirrer. Via a gas take-off tube the flask was connected to a gas meter for determining the amount of CO₂ formed during the reaction. 5508 g of N-ethylpyrrolidone were added to the raw materials mixture. Over the course of 5 minutes 2500 g of 4,4′-diisocyanatodiphenylmethane were added at room temperature to the homogeneous mixture, before the temperature was raised to 80° C. over the course of 30 minutes. On reaching 80° C., the temperature was raised at half-hour intervals by 10° C. up to a final temperature of 130° C. The reaction mixture was held at this temperature until about 90% of the amount of CO₂ indicated theoretically were detected at the gas meter.

Viscosity (100% resin): 89 900 mPa s at 23° (D=100 s⁻¹)

Mₙ=9770 g/mol; M_{w}=40 580 g/mol

b) Preparation of the Aqueous Solution 3

135 g of the polyamideimide solution 3 were heated to 50° C., admixed with 22.4 g of triethylamine and stirred for 20 minutes. Then 67 g of water (water temperature: 90° C.) were added to the resin solution over a period of 30 minutes and the mixture was stirred for 2 h. This gave a transparent solution.

Solids content: 23%

Viscosity: 1200 mPa s at 23° C. (D=1000 s⁻¹)

### Comparative Example 4 (on the Lines of U.S. Pat. No. 4,259,221)

Preparation of the Aqueous Solution 4

146.3 g of the resin from Ex. 1a were admixed with 7.7 g of a 50% strength solution of a fully ε-caprolactam-blocked 4,4′-diisocyanatodiphenylmethane (1 mol:1 mol) in N-methylpyrrolidone and the components were mixed at 80° C. for 30 minutes. Subsequently, at the same temperature, 59.7 g of dimethylethanolamine were added. The mixture was stirred for a further 30 minutes. Then 136.3 g of water preheated to 70° C. were added and the components were stirred at 85° C. for 2 h. This gave a transparent solution which after storage at room temperature for 24 h first became turbid and then began to sediment. Changes to the temperature regime during the reaction, and changes to the stirring conditions, brought no improvements, and so it was not possible to subject the resulting product to performance testing.

### Comparative Example 5 (on the Lines of U.S. Pat. No. 4,259,221; Same Composition as Example 1)

a1) Preparation of an NCO-Containing Polyamideimide Resin

1920 g of trimellitic acid anhydride were weighed out into a three-necked flask equipped with KPG stirrer. Via a gas take-off tube the flask was connected to a gas meter for determining the amount of CO₂ produced during the reaction. 3025 g of N-ethylpyrrolidone were added. Over 5 minutes the homogeneous mixture was admixed at room temperature with 1875 g of 4,4′-diisocyanatodiphenylmethane, before the temperature was raised to 80° C. over the course of 30 minutes. From about 65° C. an exothermic reaction and an associated evolution of gas were observed. On reaching 83° C., the temperature was raised at half-hour intervals by 10° C. up to a final temperature of 135° C. The reaction mixture was held at this temperature until 91% of the theoretically possible amount of CO₂ were detected at the gas counter. Despite further heating, a 100% CO₂ was not obtained.

Viscosity (mixture of 1 part by weight of resin with 3 parts by weight of N-ethylpyrrolidone): 855 mPa s at 23° C. (D=100 s⁻¹)

a2) Preparation of a Part-Blocked 4,4′-diisocyanatodiphenylmethane

625 g of 4,4′-diisocyanatodiphenylmethane were dissolved in 907.5 g of N-ethylpyrrolidone, and 282.5 g of ε-caprolactam were added. The mixture was stirred at 85° C. for 5 h until an NCO content of 6.0% was reached (theoretical NCO content 5.8%).

b) Preparation of the Aqueous Solution 5

6160 g of the resin solution obtained under a1) were mixed at 50° C. with 1815 g of the solution obtained under a2) and at this temperature was admixed with 70.2 g of triethylamine. The mixture was stirred at 50° C. for 2 hours until the two-phase system was free of NCO groups. Over the course of 10 minutes, 132.8 g of water heated at 70° C. were added to the resin solution with thorough stirring. After 5 minutes a turbid, runny solution was obtained which did not clarify even on further stirring. After just 24 h of storage at room temperature the product had a sediment which could not be redispersed even by shaking.

### Comparative Example 6 (on the Lines of U.S. Pat. No. 4,429,073)

a) Preparation of a Blocking Agent-Free Polyamideimide Resin (See Comparative Ex. 3a)

b) Preparation of the Aqueous Solution 6 (See Comparative Ex. 3b)

500 g of the transparent solution obtained under Comparative Ex. 3b were admixed over the course of 20 minutes, with stirring and at 40° C., with 11.5 g of an ε-caprolactam-blocked trimer based on 2,4-tolylene diisocyanate, in solution in 20 g of N-ethylpyrrolidone. The trimer had a blocked NCO content of 14.0% by weight. Following thorough stirring over a period of 3 h, a turbid solution was obtained.

Solids content: 24%

Viscosity: 1500 mPa s at 23° C. (D=1000 s⁻¹)

Paint Testing of the Products

Clear varnishes were obtained by mixing the amideimide-containing aqueous polymers of the invention with the components set out in Table 1.

Byk® 346, substrate wetting agent, from Byk at Wesel, Germany

Entschäumer T®, defoamer, from Borchers GmbH at Langenfeld, Germany

TABLE 1

| | | | Comparative | Comparative |
|---|---|---|---|---|
| | Example 1 | Example 2 | Example 3 | Example 6 |
| Polyamideimide | 93.7 parts | 93.7 parts | 93.7 parts | 91.5 parts |
| | solution 1 | solution 2 | solution 3 | solution 3 |
| Entschäumer T | 0.8 part | 0.8 part | 0.8 part | 0.8 part |
| Byk ® 346 | 0.5 part | 0.5 part | 0.5 part | 0.5 part |
| Dipropylene glycol | 5.0 parts | 5.0 parts | 5.0 parts | 5.0 parts |

The clear varnishes above were applied to Bonder 722 aluminum sheets from Chemetall, Frankfurt/Main, Germany, using a doctor blade (50 μm), and the coated plates were dried initially at 80° C. for 5 minutes and then baked in a forced-air oven at 260° C. for 4 minutes. This gave dry film coat thicknesses of approximately 8-10 μm.

With the products from Comparative Example 3 and 6 it was not possible to obtain a coherent film.

Tests:

DMF resistance (1 h at RT): A small cotton pad or square of cellulose was impregnated with the test substance and placed onto the varnish surface. Evaporation of the test substance was prevented by covering it with a watch glass. The cotton pad or cellulose was not allowed to dry out. After the predetermined exposure time, the test substance was removed, the exposed site was dried off and inspected immediately in order to forestall regeneration of the varnish surface.

MEK wipe test (pressure: 1 kg): The metal test panel was fastened to the weighing plate of the balance using film clips and anti-slip film. The balance was adjusted using the 100 g weight. A cotton pad impregnated with MEK was moved back and forth over the varnish film against the selected test pressure until the varnish film was destroyed.

TABLE 2
Properties of the coatings

| | Inventive Examples | | Comparative Examples |
|---|---|---|---|
| | 1 | 2 | 3 and 6 |
| Cross-cut adhesion* | 0 | 0 | It was not possible to |
| Cross-cut adhesion** | 0 | 0 | obtain coherent films |
| after impact exposure | | | |
| DMF resistance | 3 | 1-2 | |
| NMP resistance | 2 | 3 | |
| MEK wipe test*** | >100 | >100 | |
| Impact test**** | >80 | 70-80 | |
| T-Bend test | T 2 | T2 | |
| according to ECCA T 7 | | | |

*assessed according to DIN EN ISO 2409: 0 = good, 5 = poor
**assessed according to DIN EN ISO 2409: 0 = good, 5 = poor. Subsequent impact testing of the damaged site using model 304 impact tester from Erichsen (load: 30 pounds/inch)
***The number of double rubs performed until the coating is destroyed must be specified in the test report, subject to a maximum of 100 double rubs. After 100 double rubs the film was inspected for changes (matting, softening).
****A coated metal panel was subjected to defined impact stress. This stress was carried out using a falling weight with a ball bolt. The stress was directly on the varnish coating. The height of the fall before which there was no cracking when the panel deformed was reported, following calculation, as a measure (reported in “inch per pound”) for the impact elasticity.

On the basis of the spectrum of properties obtained in the case of Inventive Examples 1 and 2, these systems are suitable for the coating of metal packaging forms, such as for can coating applications, for example, more particularly for the interior coating of aerosol cans.

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. Process for preparing aqueous solutions of NCO group blocked resins having number-average molecular weights (Mₙ) of 1000 to 7000 g/mol which contain polyimide structures and optionally, polyamide structures, wherein
first, a polymer is prepared from
a) at least one polyisocyanate
b) at least one tricarboxylic monoanhydride and/or at least one tetracarboxylic anhydride and also
b1) optionally, tricarboxylic acids and/or tetracarboxylic acids and
b2) optionally, dicarboxylic acids,
c) at least one NH-functional lactam and/or 3,5-dimethylpyrazole and/or butanone oxime,
to which are optionally added further amounts of
d) at least one tricarboxylic monoanhydride and/or at least one tetracarboxylic anhydride,
d1) optionally, tricarboxylic acids and/or tetracarboxylic acids and
d2) optionally, dicarboxylic acids,
wherein the molar ratio of isocyanate groups of component a) to the sum total of the isocyanate-reactive groups of components b), b1), b2), d), d1) and d2) is 0.90:1 to 1.3:1, and the molar ratio of isocyanate groups of component a) to the isocyanate-reactive groups of component c) is 1:0.05 to 1:0.35,
the reaction mixture is subsequently reacted with
e) a base,
wherein the molar ratio of acid and/or anhydride groups of components b), b1), b2), d), d1) and d2) to the basic groups of component e) is 1:0.5 to 1:4,
and the resulting resin is dissolved in water.

2. Process for preparing aqueous solutions of NCO group blocked resins according to claim 1, wherein the resins possess number-average molecular weights (Mₙ) of 1200 to 5000 g/mol.

3. Process for preparing aqueous solutions of NCO group blocked resins according to claim 1, wherein the molar ratio of isocyanate groups of component a) to the sum total of the amounts of isocyanate-reactive groups of components b), b1), b2), d), d1) and d2) is 0.95:1 to 1.15:1, the molar ratio of isocyanate groups of component a) to the isocyanate-reactive groups of component c) is 1:0.05 to 1:0.35, and the ratio of basic groups of component e) to acid and/or anhydride groups of components b), b1), b2), d), d1) and d2) is 1:1 to 2:1.

4. Process for preparing aqueous solutions of NCO group blocked resins according to claim 1, wherein ε-caprolactam is used in component c).

5. Process for preparing aqueous solutions of NCO group blocked resins according to claim 1, wherein mixtures of 3,5-dimethylpyrazole and ε-caprolactam are used in a molar ratio of 0.1:0.9 to 0.9:0.1 in component c).

6. Process for preparing aqueous solutions of NCO group blocked resins according to claim 1, wherein for the preparation of the polymer the blocking agent c) and also components b), b1) and b2), completely or else only in part, are introduced as an initial charge and are dissolved, and then the complete or else the staged addition of component a) and, where appropriate, of retained amounts of b), b1), b2) and/or c) takes place at temperatures of 20° C. to 80° C.

7. Process for preparing aqueous solutions of NCO group blocked resins according to claim 1, wherein for the preparation of the polymer component a) is introduced as an initial charge and components b), b1), b2) and c) are then metered in, individually or in a mixture, at temperatures of 20° C. to 80° C., completely or in stages.

8. Aqueous solutions of NCO group blocked resins, obtained by a process according to claim 1.

9. Coating compositions comprising aqueous solutions of NCO group blocked resins according to claim 8.

10. Coated substrates prepared from aqueous solutions of NCO group blocked resins according to claim 8.

11. Substrates according to claim 10, wherein the substrates are metal.

12. Substrates according to claim 1, wherein the substrates are metal packaging forms.
